(19) United States
(12) Patent Application Publication
(10) Pub. No.: US 2024/0226715 A9
(43) Pub. Date: Jul. 11, 2024

(54) NON-TRANSITORY COMPUTER READABLE MEDIUM AND INFORMATION PROCESSING METHOD

(71) Applicant: CYGAMES, INC., Tokyo (JP)

(72) Inventors: Keisuke Nakahara, Tokyo (JP); Riki Nagano, Tokyo (JP); Toshihiro Arai, Tokyo (JP)

(73) Assignee: CYGAMES, INC., Tokyo (JP)

(21) Appl. No.: 18/399,267

(22) Filed: Dec. 28, 2023

Related U.S. Application Data
(63) Continuation of application No. PCT/JP22/21933, filed on May 30, 2022.

(30) Foreign Application Priority Data
Jun. 30, 2021 (JP) 2021-108635

(51) Int. Cl. A63F 13/2145; A63F 13/5255; A63F 13/55

(52) U.S. Cl. CPC A63F 13/2145; A63F 13/5255; A63F 13/55

(57) ABSTRACT

A non-transitory computer readable medium stores a program causing a computer to execute: setting a first operation region that accepts a movement operation for moving a game object displayed in a virtual game space; setting, at a position different from the position of the first operation region, a second operation region that accepts a first operation for changing a motion mode of a movement of the game object and a second operation different from the first operation; moving and displaying the game object in the virtual game space on the basis of the movement operation input to the first operation region, the first operation input to the second operation region, and an orientation of a virtual camera; and changing the orientation of the virtual camera on the basis of the second operation input to the second operation region.

### CROSS REFERENCE TO RELATED APPLICATIONS

This application is a continuation application of International Application No. PCT/JP2022/021933, filed on May 30, 2022, which claims priority to Japanese Patent Application No. 2021-108635, filed on Jun. 30, 2021, the entire contents of which are incorporated by reference herein.

### BACKGROUND ART

### Technical Field

The present invention relates to information processing programs and information processing methods.

There are well-known games in which multiple operation regions are provided on a touchscreen on which a game screen is displayed. For example, PTL 1 discloses a game in which the display of a game object is controlled on the basis of operations input to operation regions on a touchscreen.

### CITATION LIST

### Patent Literature

Patent Literature 1: JP 6447853 B

### SUMMARY OF INVENTION

### Technical Problem

When a touchscreen is provided on a game terminal device, a player needs to operate the touchscreen while grasping the game terminal device. Therefore, depending on the arrangement of the operation regions and the content of operations accepted by each of the operation regions, the operability for the player may be reduced.

An object of the present invention is to provide an information processing program and an information processing method that can improve the operability for a player.

### Solution to Problem

In order to solve the aforementioned problem, an information processing program is an information processing program that causes a computer to perform display control of a virtual game space captured by a virtual camera on the basis of an operation input to a touchscreen and causes the computer to execute: a process for setting a first operation region that accepts a movement operation for moving a game object displayed in the virtual game space; a process for setting, at a position different from the position of the first operation region, a second operation region that accepts a first operation for changing a motion mode of a movement of the game object and a second operation different from the first operation; a process for moving and displaying the game object in the virtual game space on the basis of the movement operation input to the first operation region, the first operation input to the second operation region, and an orientation of the virtual camera; and a process for changing the orientation of the virtual camera on the basis of the second operation input to the second operation region.

Also, the movement operation may include a specific operation for instructing continuation of the movement of the game object, and, in the process for moving and displaying the game object in the virtual game space, the game object may be continuously moved in a fixed direction with respect to the orientation of the virtual camera on the basis of an input of the specific operation to the first operation region.

Also, in the process for moving and displaying the game object in the virtual game space, a moving speed of the game object may be changed when the first operation is input to the second operation region in a state in which the game object is moving in the fixed direction on the basis of an input of the specific operation.

In order to solve the aforementioned problem, an information processing method is an information processing method that performs display control of a virtual game space captured by a virtual camera on the basis of an operation input to a touchscreen and that includes: a process for setting a first operation region that accepts a movement operation for moving a game object displayed in the virtual game space; a process for setting, at a position different from the position of the first operation region, a second operation region that accepts a first operation for changing a motion mode of a movement of the game object and a second operation different from the first operation; a process for moving and displaying the game object in the virtual game space on the basis of the movement operation input to the first operation region, the first operation input to the second operation region, and an orientation of the virtual camera; and a process for changing the orientation of the virtual camera on the basis of the second operation input to the second operation region.

### Effects of Disclosure

According to the present invention, the operability for a player can be enhanced.

### BRIEF DESCRIPTION OF DRAWINGS

FIG. 1 is an illustration showing a schematic configuration of an information processing system.

FIG. 2A is a diagram for illustrating the hardware configuration of a player terminal.

FIG. 2B is a diagram for illustrating the hardware configuration of a server.

FIG. 3 is a diagram for illustrating an example of a game screen.

FIG. 4 is a diagram for illustrating basic functions of each operation region.

FIG. 5 is a diagram for illustrating an example of angles and motions of a character in response to each combination of input operations.

FIG. 6 is a diagram for illustrating an example of a movement direction of the character in the on state of an auto mode.

FIG. 7 is a diagram for illustrating an example of the movement direction of the character in the case where a first pad operation region is operated and a second pad operation region is not operated.

FIG. 8A is a diagram for illustrating a first example in the case where the first pad operation region is not operated and the second pad operation region is operated.

FIG. 8B is a diagram for illustrating a second example in the case where the first pad operation region is not operated and the second pad operation region is operated.

FIG. 9 is a first diagram for illustrating a high-speed movement of the character.

FIG. 10 is a second diagram for illustrating the high-speed movement of the character.

FIG. 11 is a third diagram for illustrating the high-speed movement of the character.

FIG. 12 is a diagram for illustrating a special movement.

FIG. 13 is a diagram for illustrating a drift movement of the character.

FIG. 14 is a diagram for illustrating a drift-dash movement of the character.

FIG. 15 is a diagram for illustrating the configuration of a memory in the player terminal and functions of the player terminal as a computer.

FIG. 16 is a flowchart for illustrating a game control process in the player terminal.

FIG. 17 is a flowchart for illustrating an in-game process in the player terminal.

FIG. 18 is a flowchart for illustrating an operation determination process in the player terminal.

FIG. 19 is a flowchart for illustrating an angle decision process in the player terminal.

FIG. 20 is a flowchart for illustrating a character control process in the player terminal.

FIG. 21 is a flowchart for illustrating a high-speed movement start process in the player terminal.

FIG. 22 is a flowchart for illustrating a high-speed moving process in the player terminal.

FIG. 23 is a first flowchart for illustrating a special moving process in the player terminal.

FIG. 24 is a second flowchart for illustrating the special moving process in the player terminal.

FIG. 25 is a flowchart for illustrating a normal moving process in the player terminal.

### DESCRIPTION OF EMBODIMENTS

An aspect of an embodiment according to the present invention will be described in detail below with reference to the accompanying drawings. The numerical values, etc. given in this embodiment are merely examples for facilitating understanding and do not limit the present invention unless otherwise specifically mentioned. In this description and the drawings, the same reference signs are attached to elements having substantially the same functions and configurations, omitting repeated descriptions thereof, and elements that are not directly related to the present invention are not shown.

(Overall Configuration of Information Processing System S)

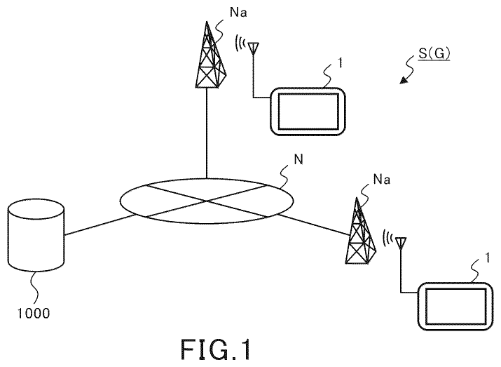

FIG. 1 is an illustration showing a schematic configuration of an information processing system S. The information processing system S is a so-called client-server system that includes: player terminals 1 each functioning as a client, i.e., a game terminal; a server 1000; and a communication network N having communication base stations Na. In the information processing system S according to this embodiment, each of the player terminals 1 and the server 1000 function as a game device G. The player terminals 1 and the server 1000 individually have assigned thereto roles for controlling the proceeding of the game such that it is possible to proceed with the game through cooperation between the player terminals 1 and the server 1000.

Each of the player terminals 1 can establish communication with the server 1000 via the communication network N. The player terminals 1 widely include electronic appliances that can be communicatively connected to the server 1000 by wire or wirelessly. Examples of the player terminals 1 include smartphones, mobile phones, tablet devices, personal computers, and game machines. This embodiment will be described in the context of the case where smartphones are used as the player terminals 1.

The server 1000 is communicatively connected to the plurality of player terminals 1. The server 1000 accumulates various types of information for each player who plays a game. Furthermore, the server 1000 executes, mainly on the basis of operations input from each of the player terminals 1, processes for updating the accumulated information, downloading images and various types of information to the player terminal 1, etc.

The communication base stations Na are connected to the communication network N, and transmit information to and receive information from the player terminals 1 wirelessly. The communication network N is configured of a mobile phone network, the Internet, a local area network (LAN), a dedicated line, etc., and realizes wired or wireless communicative connection between the player terminals 1 and the server 1000.

(Hardware Configuration of Player Terminal 1 and Server 1000)

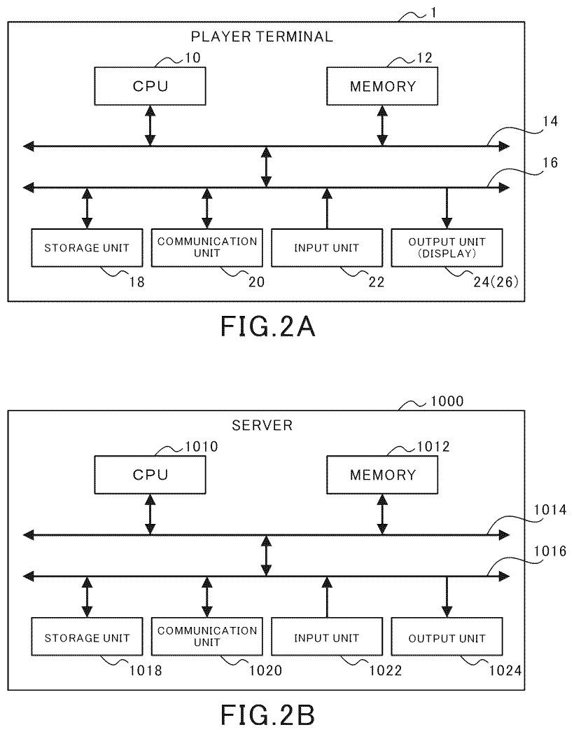

FIG. 2A is a diagram for illustrating the hardware configuration of each of the player terminals 1. Also, FIG. 2B is a diagram for illustrating the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

The configurations and functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24, respectively, of the player terminal 1. Thus, a description of the hardware configuration of the player terminal 1 will be given below, and a description of the hardware configuration of the server 1000 will be omitted.

The CPU 10 runs programs stored in the memory 12 to control the proceeding of the game. The memory 12 is configured of a read only memory (ROM) or a random access memory (RAM), and stores programs and various types of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory, such as a dynamic random access memory (DRAM), and stores various types of programs and data. At the player terminal 1, the programs and data stored in the storage unit 18 are loaded into the memory 12 (RAM) by the CPU 10.

The communication unit 20 is communicatively connected to a communication base station Na wirelessly, and transmits information to and receives information from the server 1000 via the communication network N, i.e., information including various types of data and programs. At the player terminal 1, the programs, etc. received from the server 1000 are stored in the memory 12 or the storage unit 18.

The input unit 22 is configured of, for example, a touchscreen with which player operations are input (operations are accepted).

The output unit 24 is configured to include a display device and a speaker. The output unit 24 may be a device connected (externally attached) to the player terminal 1. In this embodiment, the player terminal 1 is provided with a display 26 as the output unit 24 and is provided with a touchscreen 28 as the input unit 22, wherein the touchscreen 28 is laid over the display 26.

(Game Content)

Next, a game provided by the information processing system S and a game device G according to this embodiment will be described. In this embodiment, as an example of the game, an action game in which a player can operate a character placed in a virtual game space will be described. Here, the character moves and performs various actions within the virtual game space on the basis of player operations. The display 26 of the player terminal 1 shows an image of the virtual game space captured by a virtual camera. The player can input, to the touchscreen 28, an operation instruction for a character 40 while viewing the image displayed on the display 26. In the following, the image that is captured and generated by the virtual camera and that is displayed on the display 26 may itself be referred to as the virtual game space.

The game genres to which the technical matters described below are applicable are not limited to action games, but are applicable to all game genres, such as role playing games, shooting games, puzzle games, rhythm games, etc. Also, the game content described below is merely an example. In any case, the following technical matters are widely applicable to a game in which a game object to be operated by the player is displayed in a virtual game space captured by the virtual camera, and the game object performs a motion in the virtual game space on the basis of an operation input to the touchscreen.

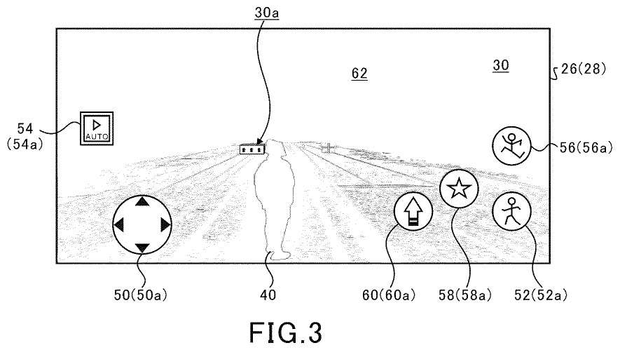

FIG. 3 is a diagram for illustrating an example of a game screen. As shown in FIG. 3, a virtual game space 30 that is captured by the virtual camera is displayed on the display 26 of the player terminal 1. In the virtual game space 30, the character 40, which is to be operated by the player, and various objects other than the character 40 are displayed. Objects other than the character 40 include obstacles, items, enemy characters, an acceleration object 30a (described in detail below), etc.

This embodiment assumes that the player plays the game while grasping the player terminal 1 in a horizontal orientation with both hands. In addition, when the display 26 and the touchscreen 28 are divided into four regions by vertical and horizontal center lines, the region located at the upper left of the display 26 and the touchscreen 28 is called an upper left region. Similarly, the regions located at the lower left, upper right, and lower right of the four-divided display 26 and touchscreen 28 are called a lower left region, an upper right region, and a lower right region, respectively. The character 40 is displayed near the boundary between the lower left and lower right regions.

A plurality of operation regions are set on the touchscreen 28 to accept a player operation. Here, a first pad operation region 50, a second pad operation region 52, an auto button operation region 54, a jump button operation region 56, a first item button operation region 58, a second item button operation region 60, and an angle operation region 62 are provided as examples of the operation regions.

Note that the position of each of the aforementioned operation regions on the touchscreen 28 is preset. However, the player can change the position of each of the operation regions in an option setting function. Note that the option setting function is not essential, and it is also acceptable that the position of each of the operation regions cannot be changed. In addition, when the option setting function is implemented, the range in which the position of each of the operation regions can be changed may be limited.

Here, it is assumed that an initial position is set for each of the operation regions, and the position of the operation region can be changed by means of the option setting function only within the range of the upper left region, lower left region, upper right region, or lower right region including the initial position.

The first pad operation region 50 is provided in the lower left region. It is a good idea to set the first pad operation region 50 within the reach of the thumb of the left hand of the player grasping the player terminal 1. The display 26 shows a first pad 50a within the range of the first pad operation region 50. The first pad 50a is an image with upward, downward, leftward, and rightward arrows marked in a circle. Note that the first pad 50a is displayed only while a valid operation is being input to the first pad operation region 50, and the first pad 50a is hidden while no valid operations are being input to the first pad operation region 50.

Here, when the input of a player operation is detected in a state in which no player operations are input, the first pad operation region 50 may be set so as to be centered on the detected position. For example, when an operation input is detected in the lower left region, the first pad operation region 50 may be set in a predetermined range with that detected position as the center coordinates.

The second pad operation region 52 is set in the lower right region. It is a good idea to set the second pad operation region 52 within the reach of the thumb of the right hand of the player grasping the player terminal 1. The display 26 shows a second pad 52a within the range of the second pad operation region 52. The second pad 52a is an image with a pattern imitating a walking human marked in a circle.

The auto button operation region 54 is provided near the boundary of the upper left region and the lower left region. It is a good idea to set the auto button operation region 54 within the reach of the thumb of the left hand of the player grasping the player terminal 1. The display 26 shows an auto button 54a within the range of the auto button operation region 54. The auto button 54a is an image with the word “AUTO” and a symbol meaning “playback” marked in a rectangle.

The jump button operation region 56 is provided near the boundary of the upper right region and lower right region. It is a good idea to set the jump button operation region 56 within the reach of the thumb of the right hand of the player grasping the player terminal 1. The display 26 shows a jump button 56a within the range of the jump button operation region 56. The jump button 56a is an image with a pattern imitating a jumping human marked in a circle.

The first item button operation region 58 and the second item button operation region 60 are provided side by side in the lower right region. It is a good idea to set the first item button operation region 58 and the second item button operation region 60 within the reach of the thumb of the right hand of the player grasping the player terminal 1. The display 26 shows a first item button 58a and a second item button 60a within the ranges of the first item button operation region 58 and the second item button operation region 60, respectively.

Although a detailed explanation is omitted, various items are placed in the virtual game space 30. The player can acquire an item as a result of the character 40 coming into contact with the item in the virtual game space 30. Each item has various predefined utilities, and the player can demonstrate a utility as a result of using an item.

The first item button 58a and the second item button 60a comprise icons indicating the items possessed by the player. Therefore, the first item button operation region 58 and the second item button operation region 60 show different first item buttons 58a and second item buttons 60a depending on the items possessed by the player. The first item button operation region 58 and the second item button operation region 60 do not need to be set if the player does not possess an item.

The angle operation region 62 is a region in which the virtual game space 30 is displayed on the touchscreen 28, excluding the aforementioned first pad operation region 50, second pad operation region 52, auto button operation region 54, jump button operation region 56, first item button operation region 58, and second item button operation region 60. Therefore, the angle operation region 62 is set across the upper left region, lower left region, upper right region, and lower right region.

Note that an operation region to which a valid operation is being input is preferably displayed in a different manner from when no valid operations are being input. In this manner, the player can recognize whether an operation is being properly input.

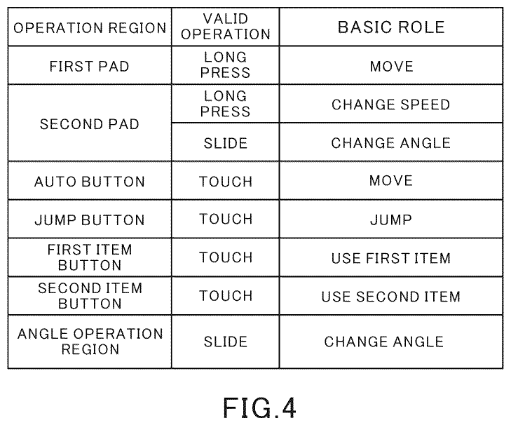

FIG. 4 is a diagram for illustrating basic functions of each of the operation regions. Valid operations, which are operations that are input by the player and treated as valid, are specified in each of the operation regions. Therefore, even if an operation is input to each of the operation regions, the operation is assumed not to have been input if the operation is not a valid operation specified for that operation region.

In the first pad operation region 50, a long-press operation is specified as a valid operation. In this embodiment, a long-press operation refers to an operation by which a contact is detected continuously for a predetermined time period or longer in the intended operation region. Note that the predetermined time period is not particularly limited, but is defined, for example, by the number of frames displayed on the display 26. Therefore, when a contact is detected continuously for a predetermined number of frames or more, it is determined that a long-press operation is being input.

A basic role assigned to the first pad operation region 50 is to accept an instruction for the movement direction of the character 40 in the virtual game space 30. That is, when a valid operation is input to the first pad operation region 50, the movement direction of the character 40 is decided on the basis of the operation position. For example, if a valid operation is input to the upper right with respect to the center coordinates of the first pad operation region 50, the character 40 moves to the right with respect to the current camera angle of the virtual camera (hereinafter, simply referred to as the angle), namely, to the far right side in the virtual game space 30 currently displayed on the display 26.

A first valid operation and a second valid operation are specified as valid operations in the second pad operation region 52. The first valid operation and the second valid operation differ from each other. Here, a long-press operation is specified as the first valid operation, and a slide operation is specified as the second valid operation. In this embodiment, a slide operation refers to an operation by which a contact is detected continuously for a predetermined time period or longer in the intended operation region while the contact position on the display 26 is moving.

Also, two different basic roles are assigned to the second pad operation region 52. The first role is to accept an instruction for changing the movement mode (moving speed) of the character 40 in the virtual game space 30. When a long-press operation is input to the second pad operation region 52 while the character 40 is moving, the movement mode (moving speed) of the character 40 is changed.

In addition, the second role is to accept an instruction for changing the angle of the virtual camera, i.e., for changing the display of the virtual game space 30 shown on the display 26. When a slide operation is input to the second pad operation region 52, the angle is changed and the virtual game space 30 displayed on the display 26 is changed.

Note that as described above, a slide operation is an operation by which a contact of the player's finger is detected continuously for a predetermined period of time on the touchscreen 28. For example, it is assumed that an operation input is detected for 100 consecutive frames within a predetermined range on the touchscreen 28. In this case, the first operation input, i.e., the operation input in the first frame, is defined as an initial operation, and the operation inputs in the second and subsequent frames are defined as continuous operations.

For a slide operation on the second pad operation region 52, the initial operation needs to be input within the range of the second pad operation region 52. That is, the first detection of the slide operation on the second pad operation region 52 is always within the range of the second pad operation region 52. On the other hand, a continuous operation of the slide operation is valid even if it exceeds the range of the second pad operation region 52. Therefore, the player only needs to start a slide operation from within the range of the second pad operation region 52, and there are no restrictions on the range of an operation input after the start of the slide operation. However, the valid range of the continuous operations may be limited to within the range of the second pad operation region 52 or to a predetermined range including the second pad operation region 52.

For example, if a slide operation is input in the left direction after the initial operation is input to the second pad operation region 52, the angle gradually moves to the left. Also, for example, if a slide operation is input in the up/down direction after the initial operation is input to the second pad operation region 52, the angle gradually moves in the up/down direction. The angle is changed in the direction of the movement of the player's finger with respect to the current angle by an amount corresponding to the amount of movement. That is, the angle is changed to follow the movement of the player's finger.

In the auto button operation region 54, a touch operation is specified as a valid operation. In this embodiment, a touch operation refers to an operation by which the detection of a contact ends within a predetermined time period after the contact is detected. Note that, in this case, the predetermined time period may be the same as or different from the time period, i.e., the number of frames, in which the operation is determined to be a long-press operation, as described above.

The basic role assigned to the auto button operation region 54 is to accept an auto mode setting operation. During the game, the player can switch the auto mode on and off. In the on state of the auto mode, the character 40 moves straight toward the angle direction, i.e., toward the far side of the virtual game space 30 shown on the display 26, regardless of whether the first pad operation region 50 is operated. When a valid operation is input to the auto button operation region 54 in the off state of the auto mode, the auto mode switches to the on state. Also, when a valid operation is input to the auto button operation region 54 in the on state of the auto mode, the auto mode switches to the off state.

In the jump button operation region 56, a touch operation is specified as a valid operation. The basic role assigned to the jump button operation region 56 is to accept an instruction for making the character 40 jump. When a valid operation is input to the jump button operation region 56, the character 40 performs a jump motion.

A touch operation is specified as a valid operation in the first item button operation region 58 and the second item button operation region 60. The basic role assigned to the first item button operation region 58 and the second item button operation region 60 is to accept an instruction for making the character 40 use an item. When a valid operation is input to the first item button operation region 58, the item corresponding to the first item button 58a is used and a predetermined utility is demonstrated. Similarly, when a valid operation is input to the second item button operation region 60, the item corresponding to the second item button 60a is used and a predetermined utility is demonstrated.

In the angle operation region 62, a slide operation is specified as a valid operation. The basic role assigned to the angle operation region 62 is to accept an instruction for changing the angle. When a slide operation is input to the angle operation region 62, the angle is changed and the display of the virtual game space 30 is changed on the display 26. Note that when a slide operation is input to the angle operation region 62, the angle is changed in the same manner as when a slide operation is input to the second pad operation region 52.

As described above, each of the operation regions is assigned a basic role, and when a valid operation is input to an operation region, the character 40 performs a motion, the angle of the virtual camera is changed, or an item is used.

Here, in this embodiment, a valid operation may be input to multiple operation regions simultaneously. Also, the movement of the character 40 and the angle are controlled by the combination of the presence or absence of a valid operation on the first pad operation region 50, the presence or absence of a valid operation on the second pad operation region 52, and the on or off state of the auto mode.

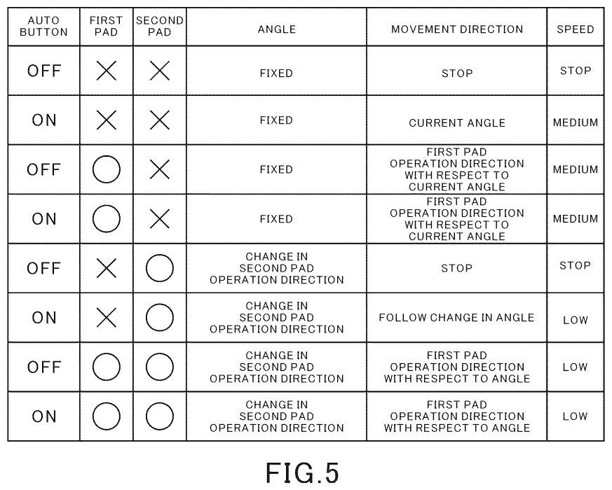

FIG. 5 is a diagram for illustrating an example of the angle and the motion of the character 40 in response to each combination of input operations. In FIG. 5, “auto button” indicates the auto button 54a, and “ON” and “OFF” marked in the “auto button” column indicate the on and off states of the auto mode, respectively. Also, in FIG. 5, “first pad” indicates the first pad operation region 50 or first pad 50a, and “second pad” indicates the second pad operation region 52 or second pad 52a. Also, in FIG. 5, “O” indicates that a valid operation is being input, and “X” indicates that no operation is being input.

For example, if the first pad operation region 50 and the second pad operation region 52 are not being operated in the off state of the auto mode, the angle is fixed without being changed. Also, in this case, the character 40 is stopped without moving.

Also, for example, if the first pad operation region 50 and the second pad operation region 52 are not being operated in the on state of the auto mode, the angle is fixed without being changed. Also, in this case, the character 40 moves toward the direction of the angle at that time, i.e., toward the far side of the virtual game space 30 shown on the display 26.

Note that, in this embodiment, the movement mode of the character 40 is classified into four patterns: a high-speed movement, a medium-speed movement, a low-speed movement, and a special movement. In the high-speed movement, the character 40 moves at the fastest speed, and an animation for the character 40 running at high speed is displayed during the high-speed movement. In the medium-speed movement, the character 40 moves slower than in the high-speed movement, and an animation for the running character 40 is displayed during the medium-speed movement. In the low-speed movement, the character 40 moves slower than in the medium-speed movement, and an animation for the walking character 40 is displayed during the low-speed movement. Hereafter, the moving speeds of the character 40 during the high-speed movement, medium-speed movement, and low-speed movement are referred to as “high speed”, “medium speed”, and “low speed”, respectively.

Note that the special movement is a special movement motion of the character 40, and the moving speed of the character 40 during the special movement is “ultra fast”, which is the same as or faster than during the high-speed movement. Details of the special movement are described below.

If the first pad operation region 50 and the second pad operation region 52 are not being operated in the on state of the auto mode, the movement mode of the character 40 is the medium-speed movement. Therefore, in this case, the character 40 moves at the medium speed toward the far side of the virtual game space 30 shown on the display 26.

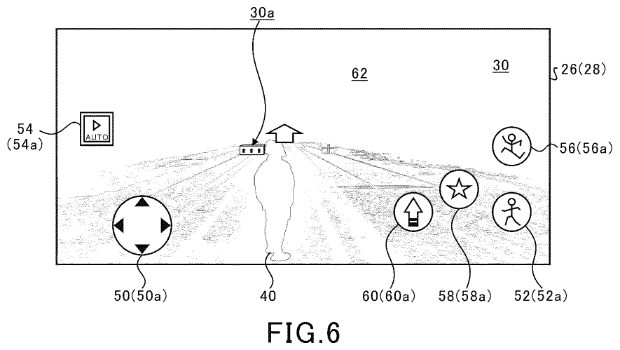

FIG. 6 is a diagram for illustrating an example of the movement direction of the character 40 in the on state of the auto mode. In the off state of the auto mode and if the first pad operation region 50 and the second pad operation region 52 are not operated, the character 40 is stationary substantially at the center in the width direction of the display 26, as shown in FIG. 6. In this state, when a valid operation is input to the auto button operation region 54 and the auto mode switches to the on state, the character 40 moves in the virtual game space 30 at the medium speed in the direction of the arrow in the figure.

Note that the display position of the character 40 hardly moves from the stationary position, and an animation for the running character 40 is displayed. At this time, the character 40 is facing forward in the movement direction. Also, the position of the virtual camera capturing the image of the virtual game space 30 moves to the far side of the virtual game space 30 shown in FIG. 6, without changing the angle. This updates the background image, i.e., the display of the virtual game space 30, on the display 26, causing the character 40 to appear as if moving toward the far side of the virtual game space 30.

Referring back to FIG. 5, when the first pad operation region 50 is operated and the second pad operation region 52 is not operated in the off state of the auto mode, the angle is fixed without being changed. Also, in this case, the character 40 moves in the operation direction in the first pad operation region 50 with respect to the angle direction at that time. In this case, the moving speed of the character 40 is the medium speed.

Furthermore, when the first pad operation region 50 is operated and the second pad operation region 52 is not operated in the on state of the auto mode, the character 40 also moves in the operation direction in the first pad operation region 50 with respect to the angle direction at that time, without the angle being changed, in the same manner as described above.

That is, the character 40 moves in the angle direction in the on state of the auto mode, but when the first pad operation region 50 is operated in this state, the character 40 moves in the operation direction in the first pad operation region 50. Therefore, it can be said that the movement direction of the character 40 is decided by prioritizing the operation on the first pad operation region 50 over the on state of the auto mode.

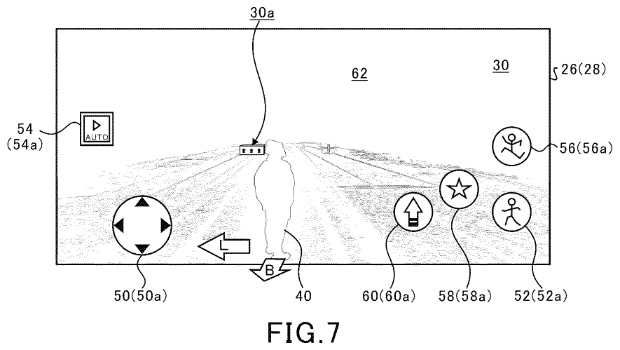

FIG. 7 is a diagram for illustrating an example of the movement direction of the character 40 in the case where the first pad operation region 50 is operated and the second pad operation region 52 is not operated. FIG. 7 shows a state in which the first pad operation region 50 and the second pad operation region 52 are not operated in the off state of the auto mode. In this state, the character 40 is stationary substantially at the center in the width direction of the display 26. In this state, when the first pad operation region 50 is operated, the character 40 moves at the medium speed in the virtual game space 30 on the basis of the operation position in the first pad operation region 50.

For example, it is assumed that a valid operation is input to the left of the center coordinates in the first pad operation region 50. In this case, the virtual camera moves to the left in the virtual game space 30 with the angle fixed. At this time, the display position of the character 40 is maintained near the center in the width direction of the display 26, and a running animation in which the character 40 faces forward in the movement direction is displayed. This causes the character 40 to appear as if moving at the medium speed in the direction of arrow L in the figure, i.e., toward the left with respect to the current angle.

It is also assumed, for example, that a valid operation is input at a position below the center coordinates in the first pad operation region 50. In this case, without the angle of the virtual game space 30 being changed, the character 40 moves at the medium speed in the direction of arrow B in the figure, i.e., in the opposite direction to the current angle.

In this manner, the character 40 moves in the virtual game space 30 on the basis of the operation position in the first pad operation region 50. Also, the virtual camera is always located behind the character 40 in the virtual game space 30, and the relative positional relationship between the character 40 and the virtual camera is constant. Therefore, it can be said that the first pad operation region 50 accepts an operation that specifies the position of the virtual camera.

Referring back to FIG. 5, if the first pad operation region 50 is not operated and the second pad operation region 52 is operated (slide operation) in the off state of the auto mode, the angle is changed in the operation direction (slide direction) in the second pad operation region 52. At this time, the character 40 is stopped without moving.

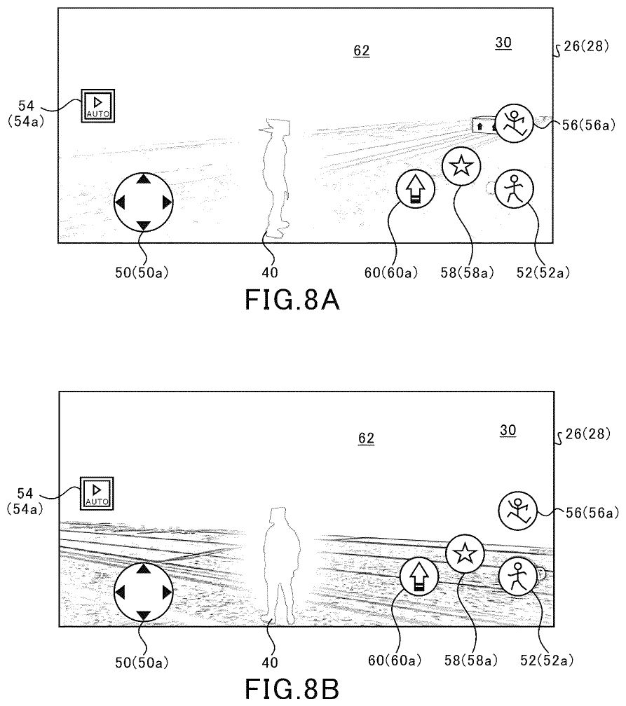

FIG. 8A is a diagram for illustrating a first example in the case where the first pad operation region 50 is not operated and the second pad operation region 52 is operated. FIG. 8B is a diagram for illustrating a second example in the case where the first pad operation region 50 is not operated and the second pad operation region 52 is operated. For example, it is assumed that a leftward slide operation is input to the second pad operation region 52 in the state shown in FIG. 6 or 7. In this case, as shown in FIG. 8A, the angle is gradually changed to the left without changing the position and orientation of the character 40 in the virtual game space 30.

For example, it is also assumed that a rightward slide operation is input to the second pad operation region 52 in the state shown in FIG. 6 or 7. In this case, as shown in FIG. 8B, the angle is gradually changed to the right without changing the position and orientation of the character 40 in the virtual game space 30.

Note that the second pad 52a may be highlighted, such as changing the color thereof, while a valid operation is being input to the second pad operation region 52. Also, for example, while a slide operation is being input to the second pad operation region 52, the second pad 52a may be moved to and displayed at the position where the contact of the player's finger is detected.

Also, for example, a circle indicating the outline of the second pad operation region 52 may be displayed while a slide operation is being input, so that a reduced version of the second pad 52a may be displayed within this circle. In this case, the second pad 52a may be displayed at a position reflecting the position of a player operation, such as being displayed to the left of the center of the circle if a leftward slide operation is being input.

Also, for example, when a continuous operation of a slide operation is input beyond the range of the second pad operation region 52, a mark with a smaller display area than the second pad 52a may be displayed at the contact position of the player's finger. This allows the player to recognize that a slide operation is being input without interfering with the visibility of the game image on the display 26.

Referring back to FIG. 5, when the first pad operation region 50 is not operated and the second pad operation region 52 is operated (slide operation) in the on state of the auto mode, the angle is changed in the operation direction (slide direction) in the second pad operation region 52. Also, in the on state of the auto mode, the character 40 moves at the low speed in the angle direction, i.e., to the far side in the virtual game space 30 that is displayed on the display 26 at that time.

When the first pad operation region 50 is not operated in the on state of the auto mode, the character 40 always moves in the angle direction at that time. Therefore, in this case, the character 40 moves to follow the direction of the angle. For example, in the examples shown in FIGS. 8A and 8B, when the auto mode switches to the on state, the character 40 will move at the low speed toward the far side in the virtual game space 30 shown on the display 26.

Also, when the first pad operation region 50 and the second pad operation region 52 are operated in the off state of the auto mode, the angle is changed in the operation direction (slide direction) in the second pad operation region 52. Also, in this case, the character 40 moves on the basis of the operation position in the first pad operation region 50 with respect to the angle direction. Therefore, in this case, because the angle direction is gradually changing, the movement direction of the character 40 is decided on the basis of the operation position in the first pad operation region 50 with respect to this changing angle direction.

For example, in the example shown in FIG. 8A, a leftward slide operation is input to the second pad operation region 52, and the angle is gradually changed to the left. During this process, when an operation is input to the left with respect to the center coordinates in the first pad operation region 50, the character 40 moves to the left relative to the virtual game space 30 shown in FIG. 8A.

Conversely, when an operation is input to the right with respect to the center coordinates in the first pad operation region 50, the character 40 moves to the right relative to the virtual game space 30 shown in FIG. 8A. In this case, if the speed at which the angle moves on the basis of the operation on the second pad operation region 52 is the same as the speed at which the character 40 and the virtual camera move on the basis of the operation on the first pad operation region 50, the character 40 is maintained in the same position. In this case, the virtual game space 30 shown on the display 26 turns in the left direction about the character 40.

Thus, when an operation on the first pad operation region 50 and a slide operation on the second pad operation region 52 are input simultaneously, the direction in which the character 40 moves is decided by combining the operation position for the first pad operation region 50 and the operation direction for the second pad operation region 52.

As shown in FIG. 5, if an operation on the first pad operation region 50 and a slide operation on the second pad operation region 52 are input simultaneously, the movement mode of the character 40 is the low-speed movement. That is, the movement mode, in other words, the moving speed, of the character 40 is determined with top priority assigned to the operation input to the second pad operation region 52.

Also, an operation on the first pad operation region 50 has priority over the on state of the auto mode. Therefore, as shown in the bottom row of FIG. 5, when the first pad operation region 50 and the second pad operation region 52 are operated in the on state of the auto mode, the angle and the movement direction of the character 40 will be the same as in the off state of the auto mode.

Here, an acceleration condition of the character 40 is set in this embodiment, and when the acceleration condition is satisfied, the movement mode of the character 40 changes to the high-speed movement for a certain period of time. The high-speed movement of the character 40 is described below.

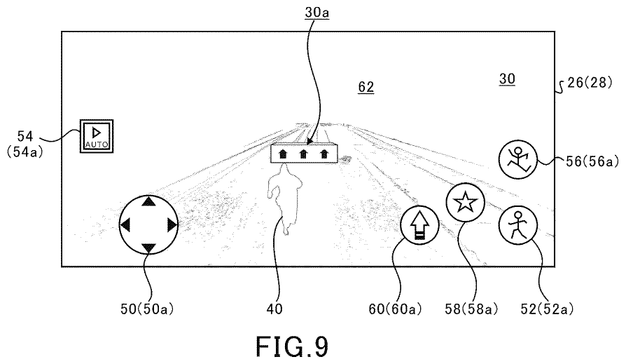

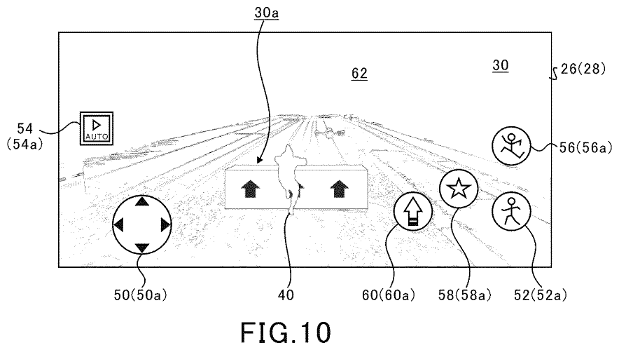

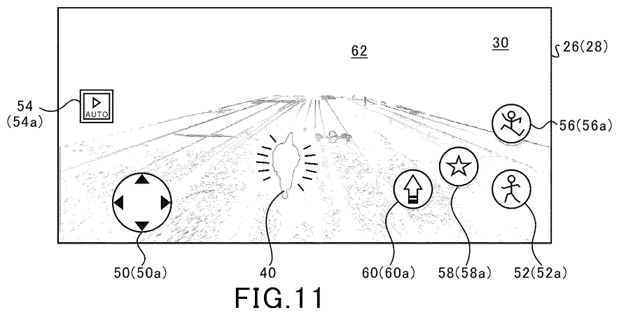

FIG. 9 is a first diagram for illustrating the high-speed movement of the character 40. FIG. 10 is a second diagram for illustrating the high-speed movement of the character 40. FIG. 11 is a third diagram for illustrating the high-speed movement of the character 40. FIGS. 9 to 11 show a state in which the first pad operation region 50 and the second pad operation region 52 are not operated in the on state of the auto mode. As shown in FIG. 9, the acceleration object 30a is placed in the virtual game space 30.

When the character 40 collides with the acceleration object 30a, an animation for jump motion of the character 40 jumping over the acceleration object 30a is displayed, as shown in FIG. 10. Then, when display of the animation for jump motion is completed, the character 40 moves at the high speed, as shown in FIG. 11. This high-speed movement continues for a predetermined time period. The predetermined time period is set, for example, to 1 to 2 seconds, and after the predetermined time period elapses, the movement mode switches to the medium-speed movement or the low-speed movement. During the high-speed movement, an animation for high-speed running is displayed. In the animation for high-speed running, an effect is displayed around the character 40, as shown in FIG. 11.

Note that a case where the character 40 collides with the acceleration object 30a in the on state of the auto mode has been described here. However, when the character 40 collides with the acceleration object 30a in the off state of the auto mode, the character 40 also starts to move at the high speed in the same manner as above. An operation on the first pad operation region 50 and the second pad operation region 52 is still valid during the high-speed movement. Therefore, for example, when an operation is input to the first pad operation region 50 during the high-speed movement, the character 40 moves at the high speed in the direction corresponding to the operation position. If the first pad operation region 50 is not operated during the high-speed movement, the character 40 moves at the high speed in the angle direction until a predetermined time period elapses.

Here, when an operation is input to the second pad operation region 52 while the character 40 is moving at the high speed, the movement mode of the character 40 changes to the special movement depending on the timing of the operation being input. The special movement of the character 40 is described below.

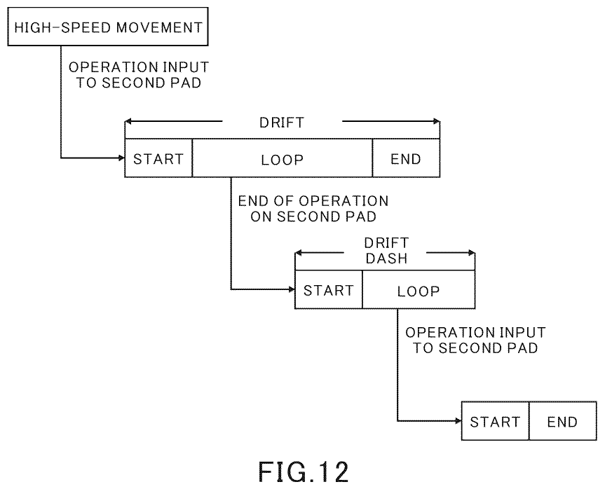

FIG. 12 is a diagram for illustrating the special movement. In this embodiment, the special movement includes two movements: a drift movement and a drift-dash movement. When a valid operation is input to the second pad operation region 52 during the high-speed movement, the movement mode of the character 40 changes to the drift movement. Note that valid operations on the second pad operation region 52 for the character 40 to perform the drift movement are both a long-press operation and a slide operation. During the drift movement, an animation for the drift movement is displayed for the character 40.

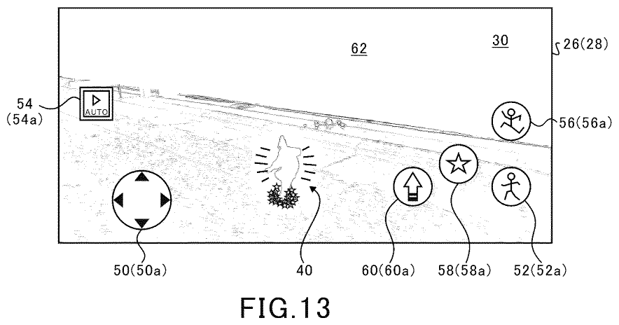

FIG. 13 is a diagram for illustrating the drift movement of the character 40. As shown in FIG. 13, during the drift movement, the character 40 moves as if sliding on the ground. At this time, the moving speed of the character 40 is about the same as that during the high-speed movement. In the animation for the drift movement, the character 40 is in a semi-crouching posture and emits sparks from its feet. During the drift movement, the player can specify the angle and the direction of movement of the character 40 by inputting a slide operation to the second pad operation region 52.

As shown in FIG. 12, the animation for the drift movement is divided into a start animation, a loop animation, and an end animation, and a playback time for each of the animations is specified. The start animation is an animation in which the character 40 is in the semi-crouching posture and consists of frames of, for example, 0.1 to 0.5 seconds. When the playback of the start animation ends, the loop animation is played back. The loop animation is an animation of sparks emitting from the feet of the character 40 in the semi-crouching posture, as shown in FIG. 13, and is played back in a loop. The loop animation is played back repeatedly over, for example, one or two seconds.

When playback of the loop animation ends, the end animation is played back. The end animation is an animation in which the posture of the character 40 returns from the semi-crouching posture to a normal posture, and consists of frames of, for example, 0.1 to 0.5 seconds.

Thus, during the drift movement, the animation for the drift movement is displayed. Although a detailed description is omitted, damage can be inflicted on an enemy character as a result of the character 40 during the drift movement colliding with the enemy character displayed in the virtual game space 30.

Note that the drift movement starts when a valid operation is input to the second pad operation region 52 during the high-speed movement and ends when a predetermined time period elapses from the start of the drift movement or when the input of the valid operation to the second pad operation region 52 ends. For example, it is assumed that the input of the valid operation to the second pad operation region 52 ends while the start animation of the drift movement is being displayed. In this case, the end animation is displayed without displaying the loop animation, and the drift movement ends.

On the other hand, if the valid operation input to the second pad operation region 52 ends while the loop animation of the drift movement is being displayed, the movement mode of the character 40 changes to the drift-dash movement. During the drift-dash movement, an animation for the drift-dash movement is displayed for the character 40.

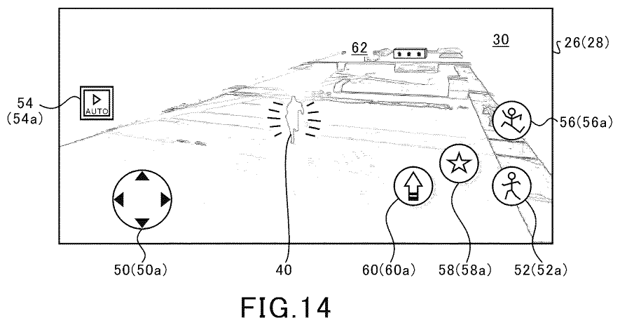

FIG. 14 is a diagram for illustrating the drift-dash movement of the character 40. As shown in FIG. 14, during the drift-dash movement, the animation for the drift-dash movement in which the character 40 is running is displayed, just as during the high-speed movement. However, the moving speed during the drift-dash movement is “super high speed,” which is faster than that during the high-speed movement. Therefore, during the drift-dash movement, the character 40 moving to the far side in the virtual game space 30 is smaller than during the high-speed movement, and its display position is also moved to an upward position on the display 26. This gives the impression of the character 40 moving so fast that the virtual camera cannot keep up with it.

As shown in FIG. 12, the animation for the drift-dash movement is divided into a start animation and a loop animation, and the playback time for each of the animations is specified. The start animation is, for example, an animation in which the character 40 rapidly accelerates, and consists of frames of, for example, 0.1 to 0.5 seconds. When the playback of the start animation ends, the loop animation is repeatedly played back.

The loop animation is an animation in which the character 40 becomes smaller and an effect is displayed around the character 40, as shown in FIG. 14, and is played back in a loop. The loop animation is played back for one or two seconds, for example. When the playback time of the loop animation elapses, the drift-dash movement ends.

When a valid operation is input to the second pad operation region 52 while the loop animation of the drift-dash movement is being displayed, a stop animation including predetermined start and end animations is played back, and the drift-dash movement ends.

Next, the functional configuration of the player terminal 1 for executing the aforementioned game will be described. Here, it is assumed that the processes for playing the aforementioned game are executed at the player terminal 1, but the processes described below may be realized through collaboration between the player terminal 1 and the server 1000. In the following, the functional configurations and processes related to the movement of the character 40 and the angle of the virtual camera in the aforementioned game are described, and descriptions of other configurations and processes are omitted.

(Functional Configuration of Player Terminal 1)

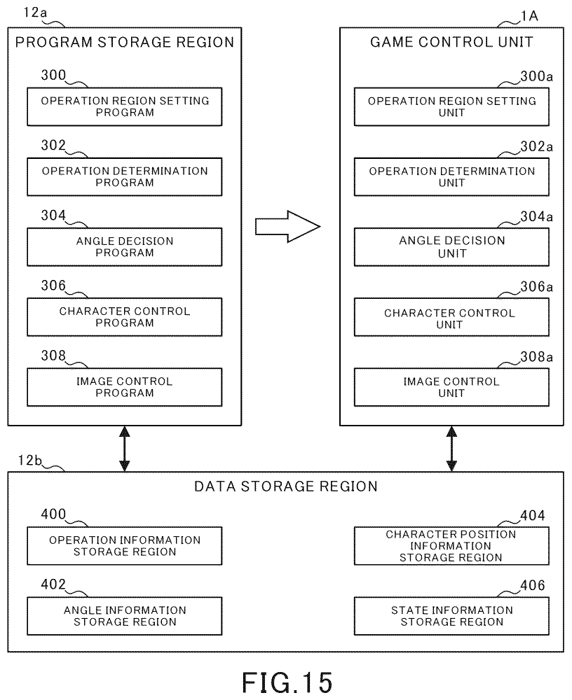

FIG. 15 is a diagram for illustrating the configuration of the memory 12 in the player terminal 1 and functions of the player terminal 1 as a computer. In the memory 12, a program storage region 12a and a data storage region 12b are provided. When a game is started, the CPU 10 stores game control programs (modules) in the program storage region 12a.

The game control programs include: an operation region setting program 300; an operation determination program 302; an angle decision program 304; a character control program 306; and an image control program 308. Note that the programs listed in FIG. 15 are examples, and a large number of other programs are also provided as the game control programs.

In the data storage region 12b, as storage sections for storing data, an operation information storage region 400, an angle information storage region 402, a character position information storage region 404, and a state information storage region 406 are provided. Note that the storage regions shown in FIG. 15 are examples, and a large number of other storage regions are provided in the data storage region 12b.

The CPU 10 runs the individual programs stored in the program storage region 12a and updates the data in the individual storage sections of the data storage region 12b. Furthermore, the CPU 10 runs the individual programs stored in the program storage region 12a, thereby causing the player terminal 1 (computer) to function as a game control unit 1A. The game control unit 1A includes: an operation region setting unit 300a; an operation determination unit 302a; an angle decision unit 304a; a character control unit 306a; and an image control unit 308a.

Specifically, the CPU 10 runs the operation region setting program 300, thereby causing the computer to function as the operation region setting unit 300a. Similarly, the CPU 10 runs the operation determination program 302, angle decision program 304, character control program 306, and image control program 308, thereby causing the computer to function as the operation determination unit 302a, angle decision unit 304a, character control unit 306a, and image control unit 308a, respectively.

The operation region setting unit 300a sets each of the operation regions on the touchscreen 28.

The operation determination unit 302a determines whether or not an operation input to each of the operation regions is a valid operation. Also, when determining that a valid operation has been input, the operation determination unit 302a stores operation information in the operation information storage region 400.

For example, when a valid operation is input to the first pad operation region 50, the operation determination unit 302a stores, in the operation information storage region 400, as the operation information, operation position information indicating the position (coordinates) at which the operation was detected. The operation position information for the first pad operation region 50 is stored in an amount equivalent to a plurality of previous frames. Also, when a valid operation is input to the second pad operation region 52, the operation determination unit 302a stores, in the operation information storage region 400, as the operation information, operation position information indicating the position (coordinates) at which the operation was detected. The operation position information for the second pad operation region 52 is stored in an amount equivalent to a plurality of previous frames.

Also, when a valid operation is input to the auto button operation region 54, the operation determination unit 302a stores, in the operation information storage region 400, as the operation information, mode information indicating the on or off state of the auto mode.

The angle decision unit 304a decides the angle of the virtual camera on the basis of a valid operation input to the second pad operation region 52 or the angle operation region 62. The angle decision unit 304a stores the decided angle in the angle information storage region 402.

The character control unit 306a decides the position, orientation, and movement mode of the character 40 on the basis of the operation information stored in the operation information storage region 400. In addition, the character control unit 306a also stores, in the character position information storage region 404, character position information indicating the current position of the character 40 in the virtual game space 30. Furthermore, the character control unit 306a stores, in the state information storage region 406, state information indicating the current movement mode of the character 40.

The image control unit 308a displays the virtual game space 30 and the character 40 on the display 26 on the basis of various types of information stored in the angle information storage region 402, character position information storage region 404, and state information storage region 406.

(Game Control Process of Player Terminal 1)

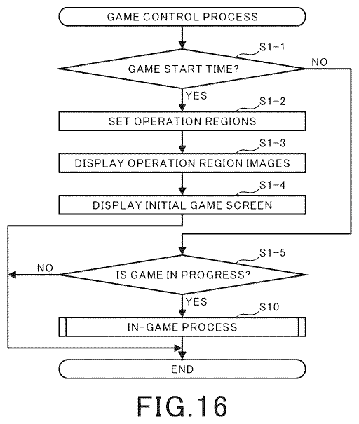

FIG. 16 is a flowchart for illustrating a game control process in the player terminal 1. When a predetermined operation for starting a game is input in the player terminal 1, the game control unit LA starts the game control process. After a predetermined operation is input, the game control process is repeatedly executed every frame until the game ends. At the time of starting the game (YES in S1-1), the operation region setting unit 300a sets operation regions on the touchscreen 28 (S1-2).

For example, the operation region setting unit 300a executes the process of setting the first pad operation region 50 that accepts an operation for moving the character 40 displayed in the virtual game space 30. Also, the operation region setting unit 300a executes the process of setting, at a position different from the first pad operation region 50, the second pad operation region 52 that accepts a first valid operation for changing the movement mode (motion mode) of the character 40 and a second valid operation different from the first valid operation.

Also, the operation region setting unit 300a displays operation region images (first pad 50a, second pad 52a, auto button 54a, jump button 56a, first item button 58a, and second item button 60a) at positions that overlay the operation regions on the display 26 (S1-3).

Note that the process of setting the operation regions in S1-2 may, for example, be a process of setting coordinate information that is referenced when identifying the presence or absence of an operation input and the operation region to be operated. Also, it can be said that the process of displaying the operation region images in S1-3 so that the player can identify each of the operation regions is the process of setting operation regions.

Also, the image control unit 308a displays an initial game screen on the display 26 (S1-4). On this initial game screen, the virtual game space 30 and the character 40 are displayed on the display 26 as shown in, for example, FIG. 6. This completes the initial setting at the time of starting the game, and thereafter, the game enters a progress state, in which the player can input various operations.

Also, during the game (YES in S1-5), an in-game process (S10) is executed.

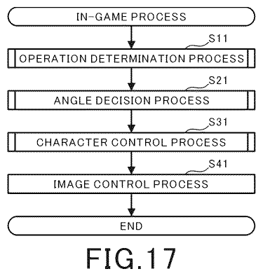

FIG. 17 is a flowchart for illustrating the in-game process in the player terminal 1. The in-game process is repeated, for example, each time the frame is updated on the display 26. In the in-game process, the operation determination unit 302a executes an operation determination process (S11), the angle decision unit 304a executes an angle decision process (S21), the character control unit 306a executes a character control process (S31), and the image control unit 308a executes an image control process (S41).

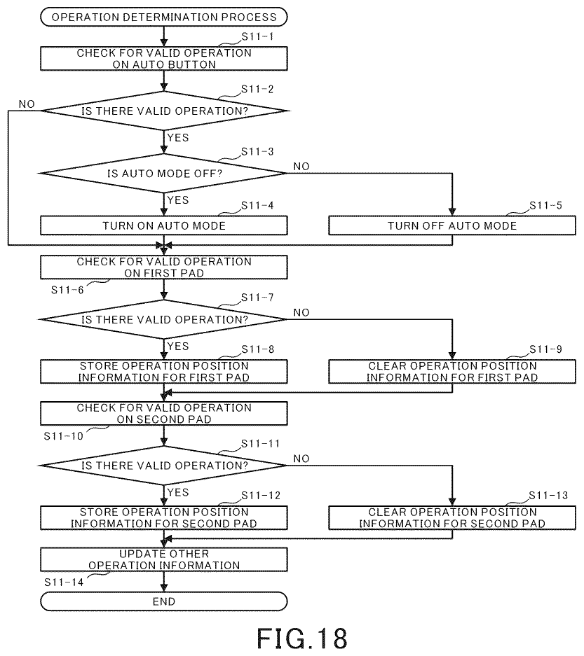

FIG. 18 is a flowchart for illustrating the operation determination process in the player terminal 1. The operation determination unit 302a checks whether or not a valid operation is being input to the auto button operation region 54 (S11-1). When a valid operation is input (YES in S11-2), the operation determination unit 302a checks the operation information in the operation information storage region 400 to determine whether the auto mode is in the off state (S11-3).

If the auto mode is in the off state (YES in S11-3), the operation determination unit 302a stores operation information indicating the on state in the operation information storage region 400 (S11-4). This causes the auto mode to switch from the off state to the on state. Also, if the auto mode is in the on state (NO in S11-3), the operation determination unit 302a stores operation information indicating the off state in the operation information storage region 400 (S11-5). This causes the auto mode to switch from the on state to the off state.

Next, the operation determination unit 302a checks whether or not a valid operation is being input to the first pad operation region 50 (S11-6). When a valid operation is input (YES in S11-7), the operation determination unit 302a stores the operation position information for the first pad operation region 50 in the operation information storage region 400 (S11-8). Also, if there is no valid operation (NO in S11-7), the operation determination unit 302a clears the operation position information for the first pad operation region 50 stored in the operation information storage region 400 (S11-9).

Next, the operation determination unit 302a checks whether or not a valid operation is being input to the second pad operation region 52 (S11-10). When a valid operation is input (YES in S11-11), the operation determination unit 302a stores the operation position information for the second pad operation region 52 in the operation information storage region 400 (S11-12). Also, if there is no valid operation (NO in S11-11), the operation determination unit 302a clears the operation position information for the second pad operation region 52 stored in the operation information storage region 400 (S11-13).

Next, the operation determination unit 302a updates the operation information in the operation information storage region 400 on the basis of whether or not a valid operation is input to the jump button operation region 56, first item button operation region 58, second item button operation region 60, and angle operation region 62 (S11-14).

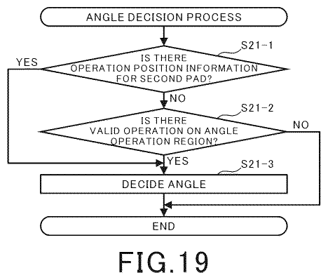

FIG. 19 is a flowchart for illustrating the angle decision process in the player terminal 1. The angle decision unit 304a determines whether or not operation position information for the second pad operation region 52 is stored in the operation information storage region 400 (S21-1). That is, here, it is determined whether or not a valid operation is being input to the second pad operation region 52. Also, if no operation position information for the second pad operation region 52 is stored in the operation information storage region 400, the angle decision unit 304a determines whether or not a valid operation on the angle operation region 62 is being input (S21-2).

If the operation position information for the second pad operation region 52 is stored (YES in S21-1) or a valid operation on the angle operation region 62 is being input (YES in S21-2), the angle decision unit 304a decides the angle on the basis of the operation position information for the second pad operation region 52 or the angle operation region 62 and the current angle stored in the angle information storage region 402 (S21-3). Also, the angle decision unit 304a stores the decided angle in the angle information storage region 402.

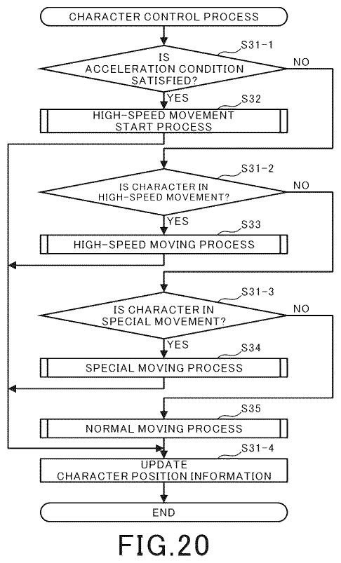

FIG. 20 is a flowchart for illustrating the character control process in the player terminal 1. The character control unit 306a determines whether or not the acceleration condition is satisfied (S31-1). The acceleration condition is a condition for the character 40 to start the high-speed movement, which in this case is that the character 40 collides with the acceleration object 30a disposed in the virtual game space 30. However, another acceleration condition, such as using a predetermined item or making a predetermined operation input, may be set.

When the acceleration condition is satisfied (YES in S31-1), the character control unit 306a executes a high-speed movement start process (S32).

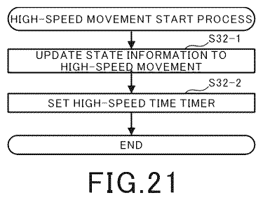

FIG. 21 is a flowchart for illustrating the high-speed movement start process in the player terminal 1. The character control unit 306a updates the state information of the character 40 stored in the state information storage region 406 to information indicating the high-speed movement (S32-1). Furthermore, the character control unit 306a also sets a predetermined timer value in a high-speed time timer that measures the time period to elapse until the end of the high-speed movement (S32-2). As a result, the movement mode of the character 40 changes to the high-speed movement.

Referring back to FIG. 20, if the acceleration condition is not satisfied (NO in S31-1), the character control unit 306a checks the state information stored in the state information storage region 406 to determine whether or not the character is in the high-speed movement (S31-2). If the character is in the high-speed movement (YES in S31-2), the character control unit 306a executes a high-speed moving process (S33).

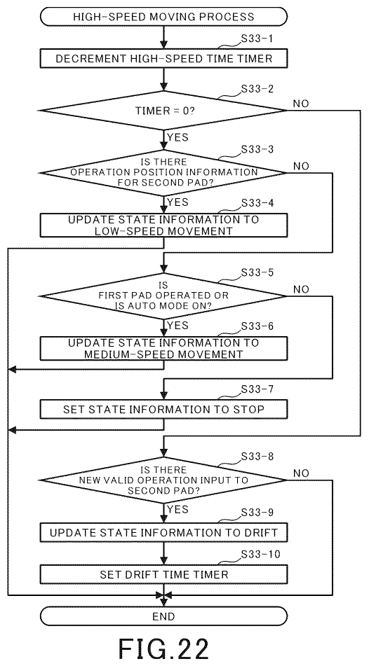

FIG. 22 is a flowchart for illustrating the high-speed moving process in the player terminal 1. The character control unit 306a decrements the high-speed time timer (S33-1) and determines whether or not the timer value of the high-speed time timer after the decrement is 0 (S33-2). If the timer value is 0 (YES in S33-2), i.e., the time period until the end of the high-speed movement has elapsed, the character control unit 306a determines whether or not there is operation position information for the second pad operation region 52 (S33-3). If there is operation position information for the second pad operation region 52 (YES in S33-3), the character control unit 306a updates the state information of the character 40 stored in the state information storage region 406 to information indicating the low-speed movement (S33-4).

On the other hand, if there is no operation position information for the second pad operation region 52 (NO in S33-3), the character control unit 306a determines whether or not there is operation position information for the first pad operation region 50 or whether or not the auto mode is in the on state (S33-5). If there is operation position information for the first pad operation region 50 or the auto mode is in the on state (YES in S33-5), the character control unit 306a updates the state information of the character 40 stored in the state information storage region 406 to information indicating the medium-speed movement (S33-6).

Also, if there is no operation position information for the first pad operation region 50 and the auto mode is in the off state (NO in S33-5), the character control unit 306a updates the state information of the character 40 stored in the state information storage region 406 to information indicating the stop (S33-7).

If the timer value of the high-speed time timer is not 0 (NO in S33-2), the character control unit 306a determines whether or not a new valid operation is input to the second pad operation region 52 (S33-8). That is, here, it is determined whether or not the input of a new operation is detected in a state in which no operation is input to the second pad operation region 52 during the high-speed movement.

If a new valid operation is input to the second pad operation region 52 (YES in S33-8), the character control unit 306a updates the state information of the character 40 stored in the state information storage region 406 to information indicating the drift movement (S33-9). This changes the movement mode of the character 40 from the high-speed movement to the drift movement.

Note that the state information indicating the drift movement includes three items of information: drift start information, drift loop information, and drift end information. Here, the drift start information is stored as the state information in the state information storage region 406. Also, the character control unit 306a sets a predetermined timer value in a drift time timer that measures the time period to elapse until the end of the drift movement (S33-10). Note that the high-speed time timer is reset here.

Referring back to FIG. 20, if the character 40 is not in the high-speed movement (NO in S31-2), the character control unit 306a checks the state information stored in the state information storage region 406 to determine whether or not the character 40 is in the special movement (S31-3). If the character 40 is in the special movement (YES in S31-3), the character control unit 306a executes a special moving process (S34).

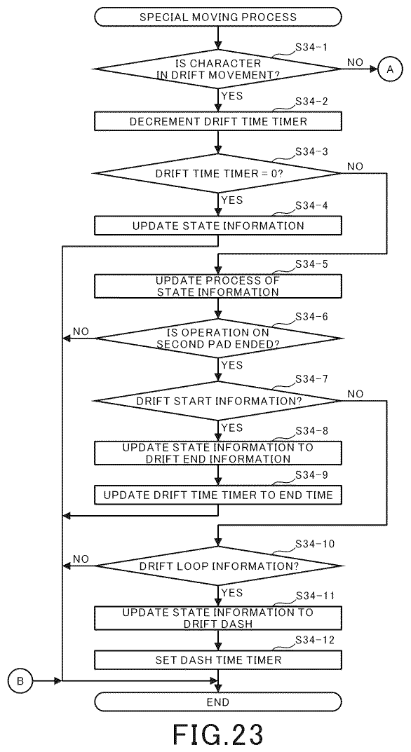

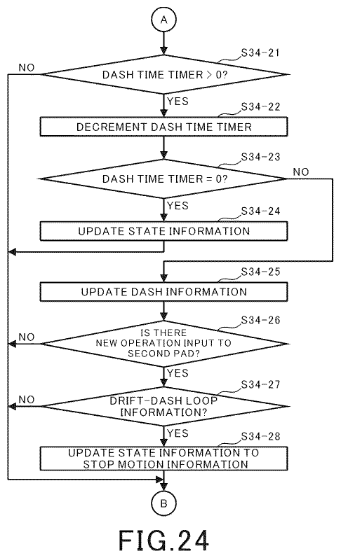

FIG. 23 is a first flowchart for illustrating the special moving process in the player terminal 1, and FIG. 24 is a second flowchart for illustrating the special moving process in the player terminal 1. The character control unit 306a checks the state information stored in the state information storage region 406 to determine whether or not the character 40 is in the drift movement (S34-1). If the character 40 is in the drift movement (YES in S34-1), the character control unit 306a decrements the drift time timer (S34-2) and determines whether or not the timer value of the drift time timer after the decrement is 0 (S34-3).

If the timer value is 0 (YES in S34-3), i.e., the time period until the end of the drift movement has elapsed, the character control unit 306a updates the state information in the state information storage region 406 to predetermined information (S34-4). Here, for example, if a valid operation is being input to the second pad operation region 52, the state information is updated to information indicating the low-speed movement. Also, if, for example, a valid operation is being input to the first pad operation region 50 or if the auto mode is in the on state, the state information is updated to information indicating the medium-speed movement. If the auto mode is in the off state and no valid operation is being input to either the first pad operation region 50 or the second pad operation region 52, the state information is updated to information indicating the stop.

Also, if the timer value of the drift time timer is not 0 (NO in S34-3), the character control unit 306a executes an update process of the state information stored in the state information storage region 406 (S34-5). Specifically, the timer value of the drift time timer at which the drift start information is updated to the drift loop information and the timer value of the drift time timer at which the drift loop information is updated to the drift end information are preset. Here, the timer value of the drift time timer is checked, and if the timer value is a value at which the state information should be updated, the state information is updated as described above.

Also, when a valid operation on the second pad operation region 52 ends (YES in S34-6), the character control unit 306a determines whether or not the drift start information is stored as the state information in the state information storage region 406 (S34-7). If the drift start information is stored (YES in S34-7), the state information is updated to the drift end information (S34-8), and the timer value corresponding to the playback time of the end animation is set in the drift time timer (S34-9). As a result, when the operation on the second pad operation region 52 ends during the playback of the start animation of the drift movement, the loop animation is skipped and the end animation is played back.

Also, if the drift loop information is stored as the state information in the state information storage region 406 (YES in S34-10) when the valid operation on the second pad operation region 52 ends during the drift movement, the character control unit 306a updates the state information to information indicating the drift-dash movement (S34-11). Note that the state information indicating the drift-dash movement includes drift-dash start information and drift-dash loop information. Here, the drift-dash start information is stored as the state information in the state information storage region 406. As a result, the movement mode of the character 40 changes to the drift-dash movement. Also, the character control unit 306a sets a predetermined timer value in a dash time timer that measures the time period to elapse until the end of the drift-dash movement (S34-12). Note that the drift time timer is reset here.

Also, it is determined that the character 40 is not in the drift movement in S34-1 (NO in S34-1) if the movement mode of the character 40 is set to the drift-dash movement. If the character 40 is in the drift-dash movement, the character control unit 306a determines whether or not the timer value of the dash time timer is greater than 0 (S34-21), as shown in FIG. 24. If the timer value is greater than 0 (YES in S34-21), the character control unit 306a decrements the dash time timer (S34-22) and determines whether or not the timer value of the dash time timer after the decrement is 0 (S34-23).

If the timer value is 0 (YES in S34-23), i.e., the time period until the end of the drift-dash movement has elapsed, the character control unit 306a updates the state information in the state information storage region 406 to predetermined information (S34-24). Here, the state information is updated in the same manner as described in S34-4.

Also, if the timer value of the dash time timer is not 0 (NO in S34-23), the character control unit 306a executes an update process of the state information stored in the state information storage region 406 (S34-25). Specifically, the timer value of the dash time timer at which the drift-dash start information is updated to the drift-dash loop information is preset. Here, the timer value of the dash time timer is checked, and if the timer value is a value at which the state information should be updated, the state information is updated to the drift-dash loop information.

When a new valid operation is input to the second pad operation region 52 (YES in S34-26), the character control unit 306a determines whether or not the drift-dash loop information is stored as the state information in the state information storage region 406 (S34-27). If the drift-dash loop information is stored (YES in S34-27), the character control unit 306a updates the state information to predetermined stop motion information (S34-28). Although a detailed explanation is omitted, when stop motion information is stored as the state information, the aforementioned stop animation is displayed. This will result in the end of the drift-dash movement.

Referring back to FIG. 20, if the character 40 is not in the special movement (NO in S31-3), the character control unit 306a executes a normal moving process (S35).

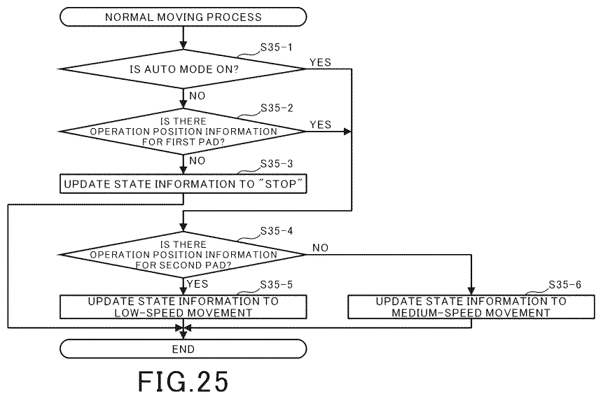

FIG. 25 is a flowchart for illustrating the normal moving process in the player terminal 1. The character control unit 306a determines whether or not the auto mode is in the on state (S35-1). If the auto mode is not in the on state (NO in S35-1), the character control unit 306a determines whether or not there is operation position information for the first pad operation region 50 (S35-2). If there is no operation position information for the first pad operation region 50 (NO in S35-2), the character control unit 306a updates the state information to information indicating the stop (S35-3).

On the other hand, if the auto mode is in the on state (YES in S35-1) or there is operation position information for the first pad operation region 50 (YES in S35-2), the character control unit 306a determines whether or not there is operation position information for the second pad operation region 52 (S35-4). If there is operation position information for the second pad operation region 52, the character control unit 306a updates the state information of the character 40 stored in the state information storage region 406 to information indicating the low-speed movement (S35-5). In contrast, if there is no operation position information for the second pad operation region 52, the character control unit 306a updates the state information of the character 40 stored in the state information storage region 406 to information indicating the medium-speed movement (S35-6).

The aforementioned normal moving process decides the movement mode of the character 40, as shown in FIG. 5.

Referring back to FIG. 20, when the state information is updated as described above, the character control unit 306a updates the character position information indicating the current position of the character 40 in the character position information storage region 404 (S31-4). Here, the position of the character 40 in the current frame is derived on the basis of the operation information stored in the operation information storage region 400, the angle stored in the angle information storage region 402, the state information stored in the state information storage region 406, and the character position information stored in the character position information storage region 404 in the previous frame.

Also, in the image control process shown in FIG. 17, on the basis of the various information decided and stored in the character control process as described above, the image control unit 308a decides and displays an animation of the character 40 and the virtual game space 30 to be displayed on the display 26.

As described above, according to this embodiment, the first pad operation region 50 (first operation region) and the auto button operation region 54 (first operation region) are set to accept an operation for moving the character 40 (movement operation) displayed in the virtual game space 30. In addition, the second pad operation region 52 (second operation region) that accepts the first valid operation (first operation) for changing the movement mode (motion mode) of the movement of the character 40 and the second valid operation (second operation) that is different from the first valid operation (first operation) is set at a position different from the positions of the first pad operation region 50 (first operation region) and the auto button operation region 54 (first operation region).

Also, the character 40 (game object) is moved and displayed in the virtual game space 30 on the basis of the operation (movement operation) input to the first pad operation region 50 (first operation region) and the auto button operation region 54 (first operation region), the first valid operation (first operation) input to the second pad operation region 52 (second operation region), and the orientation of the virtual camera. Also, the orientation of the virtual camera is changed on the basis of the second valid operation (second operation) input to the second pad operation region 52 (second operation region).

Thus, in this embodiment, the second pad operation region 52 accepts two different types of valid operations. Also, on the basis of the accepted valid operation, the movement mode of the character 40 is changed or the angle of the virtual camera is changed. This allows the player to, for example, change the movement mode of the character 40 or the angle by operating one region with the right hand while operating the movement direction of the character 40 with the left hand, thereby improving the operability.

Although an aspect of an embodiment has been described with reference to the accompanying drawings, it goes without saying that the present invention is not limited to the aforementioned embodiment. It would be obvious that a person skilled in the art could conceive of various modifications and amendments within the scope recited in the claims, and it will be understood that those modifications and amendments obviously belong to the technical scope.

In the aforementioned embodiment, the auto button operation region 54 is provided, and the auto button operation region 54 accepts an operation for instructing the continuation of movement of the character 40, i.e., an operation for switching the auto mode to the on state (specific operation). On the basis of the input of an operation for switching the auto mode to the on state (specific operation) to the auto button operation region 54, the character 40 (game object) continuously moves in a certain direction with respect to the orientation of the virtual camera.

Also, during this time, when the first valid operation (first operation) is input to the second pad operation region 52 (second operation region), the moving speed of the character 40 (game object) is changed. In this embodiment, the moving speed of the character 40 is reduced by inputting the first valid operation to the second pad operation region 52, but the moving speed may, for example, be increased. Also, instead of changing the speed, for example, the animation of the character 40 may be changed, or the character 40 may be changed to a state in which it can inflict damage on an enemy character, as in the aforementioned drift movement.

Note that the auto button operation region 54, i.e., the auto mode, is not essential. Contrary to this, the auto button operation region 54 may be provided, and the first pad operation region 50 need not be provided. That is, only one of the first pad operation region 50 and the auto button operation region 54 may be provided, or both may be provided, as in the aforementioned embodiment.

Also, the jump button operation region 56, first item button operation region 58, second item button operation region 60, and angle operation region 62 are not essential.

Also, the game content in the aforementioned embodiment is merely an example. In the aforementioned embodiment, the character 40 moves on the basis of the input of a player operation, but the game object that moves on the basis of the input of a player operation is not limited to the character 40. In any case, it suffices if a game object displayed in the virtual game space 30 moves on the basis of a movement operation accepted by the first pad operation region 50 or the auto button operation region 54.

In the aforementioned embodiment, the high-speed movement and the special movement are provided as the movement mode of the character 40. Also, during the high-speed movement, the movement mode is changed to the drift movement on the basis of an operation input to the second pad operation region 52. That is, the second pad operation region 52 accepts different motion instructions for the character 40 between when the character 40 is in the high-speed movement and when the character 40 is in a movement other than the high-speed movement. In this manner, because the common second pad operation region 52 accepts different motion instructions, it is possible to suppress cumbersome operations while still improving the fun of the game.

Also, in the aforementioned embodiment, a long-press operation and a slide operation are specified as valid operations on the second pad operation region 52. However, the mode of operation accepted by the second pad operation region 52 is not limited to this. For example, a touch operation may be specified as a valid operation instead of the long-press operation, and a flick operation may be specified as a valid operation instead of the slide operation.

Furthermore, the processes in the player terminal 1 in the aforementioned embodiment are merely examples. It is needless to say that the processes in the player terminal 1 can be designed as appropriate without departing from the purpose of the present invention.

In the aforementioned embodiment, the player terminal 1 is provided with one CPU 10 and one memory 12, and the one CPU 10 and one memory 12 function as the controller for controlling the game. However, there may be one or more CPUs 10 and one or more memories 12. In any case, it suffices if one or more controllers carry out the processes for executing the aforementioned game. Thus, for example, the player terminal 1 and the server 1000 may each be provided with a controller, and the processes for executing the game may be carried out by the controller of the player terminal 1 and the controller of the server 1000.

The information processing program for executing the processes in the aforementioned embodiment may be stored in a computer-readable non-transitory storage medium and provided as a non-transitory storage medium. Furthermore, a game terminal device including this storage medium may be provided. The aforementioned embodiment may also be an information processing method that realizes each function and the steps shown in the flowcharts.

What is claimed is:

1. A non-transitory computer readable medium storing a program causing a computer to perform display control of a virtual game space captured by a virtual camera on the basis of an operation input to a touchscreen, the program causing the computer to execute:
setting a first operation region that accepts a movement operation for moving a game object displayed in the virtual game space;
setting, at a position different from the position of the first operation region, a second operation region that accepts a first operation for changing a motion mode of a movement of the game object and a second operation different from the first operation;
moving and displaying the game object in the virtual game space on the basis of the movement operation input to the first operation region, the first operation input to the second operation region, and an orientation of the virtual camera; and
changing the orientation of the virtual camera on the basis of the second operation input to the second operation region.

2. The non-transitory computer readable medium according to claim 1,
wherein the movement operation includes a specific operation for instructing continuation of the movement of the game object, and
moving and displaying the game object in the virtual game space includes continuously moving the game object in a fixed direction with respect to the orientation of the virtual camera on the basis of an input of the specific operation to the first operation region.

3. The non-transitory computer readable medium according to claim 2,
wherein moving and displaying the game object in the virtual game space includes changing a moving speed of the game object when the first operation is input to the second operation region in a state in which the game object is moving in the fixed direction on the basis of the input of the specific operation.

4. An information processing method for performing display control of a virtual game space captured by a virtual camera on the basis of an operation input to a touchscreen, comprising:
setting a first operation region that accepts a movement operation for moving a game object displayed in the virtual game space;
setting, at a position different from the position of the first operation region, a second operation region that accepts a first operation for changing a motion mode of a movement of the game object and a second operation different from the first operation;
moving and displaying the game object in the virtual game space on the basis of the movement operation input to the first operation region, the first operation input to the second operation region, and an orientation of the virtual camera; and
changing the orientation of the virtual camera on the basis of the second operation input to the second operation region.
